(19) United States
(12) Patent Application Publication
(10) Pub. No.: US 2019/0012694 A1
(43) Pub. Date: Jan. 10, 2019

(54) MEMBER GOODS REGISTRATION MULTILEVEL-MARKETING BUSINESS SYSTEM

(71) Applicant: Haruhisa ONOZUKA, Tokyo (JP)

(72) Inventor: Haruhisa ONOZUKA, Tokyo (JP)

(21) Appl. No.: 16/068,123

(22) PCT Filed: Nov. 18, 2016
(86) PCT No.: PCT/JP2016/084324

§ 371 Date: Jul. 4, 2018

(30) Foreign Application Priority Data
Jan. 4, 2016 (JP) 2016-009251

(51) Int. Cl. G06Q 30/02; G06Q 10/06

(52) U.S. Cl. CPC G06Q 30/0236; G06Q 10/06395; G06Q 10/06311

(57) ABSTRACT

The fact that the business is stagnant in the multilevel sales business, and the general public who became a member for the purpose of earning a certain income is damaged financially, and it has become the cause of social problems. The fact that the products that members can sell are limited to the product of a multilevel marketing business company and that the means by which the member is paid is limited only to the business behavior of selling goods and soliciting sales members. In the multilevel marketing business system, we establish a method to add to the reward item as a result of the member registered the product which becomes the seller, and the member who registers the product which becomes the seller is voluntarily established, and this is systemized.

### TECHNICAL FIELD

The present invention relates to a multilevel sales business system that is limited to two types of business actions to be managed, the sale of goods provided by business operators, and the solicitation of members to sell the goods. The member itself relates to a multilevel sales business system for the registration of member products, which is added as a business action to the Seller and the solicitation action of the member product sales member.

Establish a method to add to the reward item as a result of membership that the member has solicited a member to register the product to be the seller by oneself, and this is systemized.

### BACKGROUND TECHNOLOGY

The business form of multilevel sales business is known as (“Multilevel Marketing” or “Network Business”).

In this multilevel sales business, a business operator who develops, manufactures, and sells products, creates a network as a member, and engages in the company's business, such as sales and marketing of products as a member of the product. We will provide members with compensation, etc. commensurate with their performance.

In this multilevel marketing business, it is common to set up a certain qualification based on the performance of the member, and to form a multi-stage sales organization based on this qualification.

Members can expand their distribution network by not only selling products to consumers but also inviting (soliciting) others to do business.

In addition to the retail income generated by the sale of goods to the general consumer, the remuneration provided to members is derived from the members themselves and their members, and the remuneration incurred by the purchase results of the network group that they have built. In addition, compensation is included in response to efforts to guide and foster group members of the network.

That is, the remuneration of the member consists of the remuneration by the retail profit of the member individual and the reward brought by the group activity of the network to which the member belongs.

And the remuneration consists of monetary compensation and other remuneration, and non-monetary rewards include promotion of membership qualifications and dispatch to training trips.

### SUMMARY OF THE INVENTION

### The Problems that are to be Solved by the Invention

Business is delayed in the multilevel sales business, and the general public who became a member for the purpose of earning a certain income is damaged financially, is the cause of social problems. The fact that the products that members can sell are limited to the product of a multilevel marketing business company and that the means by which the member is paid is limited only to the business behavior of selling goods and soliciting sales members.

Thus, in the multilevel sales business, it is limited to the business person to be able to supply the product, and because the product genre and the product to be handled are specified, the member is in the state that it is not possible to select the product from the limited product and to sell it. In addition, the product is often a single item in the Multilevel Sales business Company.

In this way, a member engaged in a multilevel marketing business is limited in the products that can be sold, the market is in a difficult situation to get a limited and stable reward.

Like this, if there is no supply of goods that are continuously in demand from the business operator who is the sole supplier, it is difficult for the Member who has made a great effort for many years to expand the product distribution network to obtain a permanent, stable reward.

Every product has a life cycle, and if the business operator cannot continue to develop and supply marketable products, the multilevel sales business will be stagnant.

In the present situation, there are many cases where multilevel sales business operators are declining to match the life cycle of the product.

In order to increase the soundness of the multilevel sales business, it is necessary to review the system structure of the multilevel sales business to identify potential problems of the members in the business.

The essence of problem of multilevel sales business is that operators and their most recent minority members are getting a lot of revenue from many members of the general public.

The multilevel sales business is a situation where the general public who participates with the purpose of obtaining the reward cannot not sell items as expected, There are few situations where it is often stuck.

It is necessary to start with the recognition that it is the social value of a multilevel sales business that many ordinary citizens can obtain a certain reward. It is the present invention that was born from the recognition.

The social existence of a multilevel sales business is positioned to ensure that ordinary consumers without general special skills and expertise are able to obtain certain rewards permanently, this method is established and is a system.

### Means to Solve the Problems

The present invention was made under such circumstances, and the purpose is to establish the method of the multilevel sales business member to be able to do the product sale, the sales member solicitation, the product registration which the member is a seller, and the product registration member solicitation that the member is the seller, It is a system that targets the rewards of these business actions, diversifying opportunities to obtain rewards, establishes a method for members to register products, promotes the supply of new products, and ensures the persistence of the multilevel sales business.

In addition, in the multilevel sales business it is hoped that the member who has expanded the product distribution network with a lot of effort for many years would obtain a permanent reward corresponding to the effort. The present invention corresponds to the efforts of the members, it is a system that enables to obtain a permanent reward.

Member product registration multilevel Sales Business System related to the present invention, the member product information Registration Department to register a product that is the seller of the company to sell in the distribution channel of the multilevel sales, members engaged in the multilevel sales business. It has an order management system for managing the order of goods with the member as the seller.

The above member product registration Multilevel Sales Business System, in addition, the member qualification extraction Department of the product registration Member Solicitation Group to extract the group membership qualification that solicited the member who registered the product of the seller itself, It has a qualification management system to manage the membership of the product Registration Member solicitation Group.

The member group, which is qualified to receive the remuneration, is managed by the qualification management system of the core system when the product is registered by the Member qualification Extraction Department of the product registration Member solicitation Group.

The member product registration Multilevel Sales business will form a multi-stage solicitation group membership based on the recruitment results of members' product registration.

The qualification management system in the core system of the membership product registration Multilevel sales Business system above, the ability to extract the remuneration received by the member of the Product Registration Member Solicitation Qualification group members from the performance of the product that the seller has sold.

Members of the member product registration multilevel sales Business can expand not only the product sales network but also the product supply network by inviting others to the business.

And the remuneration provided to the member, in addition to the retail profit generated by selling the goods to the general consumer, generated from the member himself and members of the member solicited, The reward generated by the record of product purchase of the network that oneself built and the product registration sales of the network that oneself built is included, and the reward according to the effort to guide and to foster the member of the network, etc.

That is, the remuneration of the member consists of remuneration by the performance of the member individual and the reward brought by the activity of the network group to which the member belongs.

The financial reward of members of the member product registration multilevel Sales business is the sales profit of the product of the multilevel sales business, the sales profit of the product registered as the seller, and the sales profit of the product of the solicitation member. It is the sales profit of the product which is registered by solicitation member as a seller.

Non-monetary rewards include promotion of membership qualifications and dispatch to training trips.

In the current multilevel sales business, because there is no way to sell products that are not provided by other companies, only the order management system that manages the order of goods from the members is set up in the core system of the member support.

In the multilevel sales business system of the member product registration, the business of managing the order of the product to the member is added because the new member sells the product which becomes a seller. Therefore, the order management system is added to the conventional order management system. This is the order management system.

In addition, in the current multilevel sales business, because it does not sell goods that are provided by non-business operators, the qualification management system of the core system, based on the performance of sales of business goods and the solicitation results of the product sales members, The membership was set to determine the rewards.

In the multilevel sales business system of the member product registration, the solicitation of the member who becomes the seller of such a commodity is also a result because a new member sells the product which becomes a seller.

Therefore, the qualification management system of the member product registration multilevel Sales Business system, based on the results of solicitation of the member to be the seller of such products and the sales performance of the entire network of the registered product of said member, we will add a system to set a new qualification to determine the remuneration of the Members who solicited the member.

In this way, the qualification management system will be a new system for managing the qualifications of both parties, as members may obtain rewards related to product sales and rewards related to the delivery of goods.

The member product Information Registration Department is newly established in the member management system of the core system. The member who becomes the seller is stored in the product storing part, and the commodity information is managed by the commodity order management system when the product description, specifications, and the price, etc. are registered to the member Product information Registration Department of the member management system.

In addition, a new product Registration Member Solicitation Group Member Qualification Division is set up in the qualification management system of the core system. When the member who becomes the seller voluntarily registers with the member management system, the member information is sent to the qualification management system, the membership of the product Registration Member Solicitation Group is extracted, and it is stored in the credential storing part.

Thus, the recruitment group membership is set up and managed by the qualification management system to meet the conditions under which the sales results of the registered product are paid.

### Effect of Invention

This is not only for product sales and solicitation of sales members, The act of inviting members to register their own products by using the multilevel selling system of the member product registration and the member product registration multilevel sales system and the member itself becomes the seller joins the business action, Member product registration multilevel sales opportunities to earn the rewards of business members become diverse and It is possible to stabilize the income.

In addition, by registering the product that the member of the member product registration multilevel sales business becomes the seller voluntarily, the product of various genres is supplied abundantly, and the product genre is diversified as for the product that the member product registration multilevel sales business handles, and the persistence of the enterprise is maintained, and the persistence of the reward that the member obtains is ensured, too.

### BRIEF DESCRIPTION OF THE DRAWING

FIG. 1 is a functional block diagram showing the core system configuration of the member product registration multilevel sales Business according to the present invention.

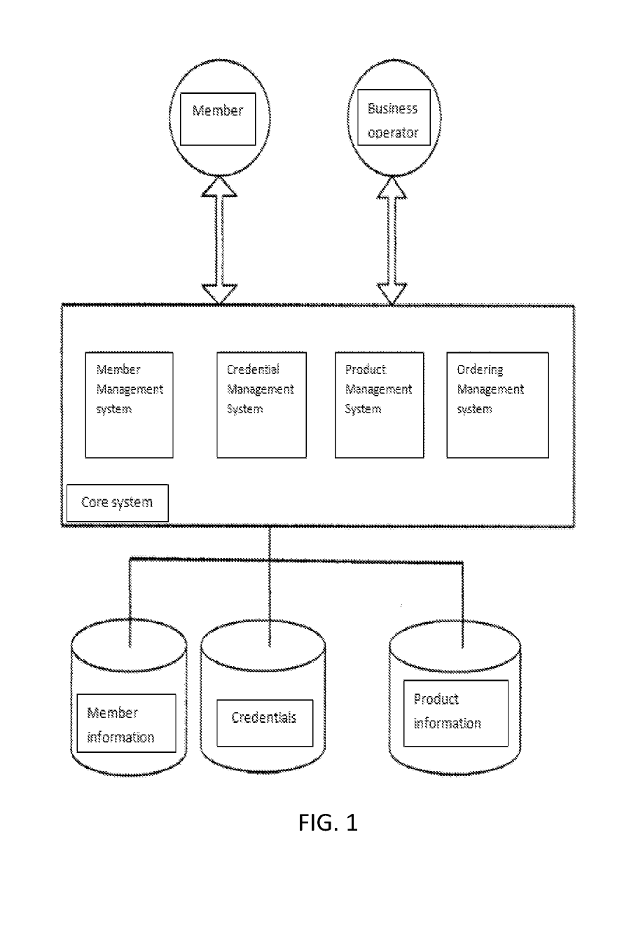

FIG. 2 is a flowchart of the flow of the product registration information that members enter the member Product Information Registration Department installed in the member management system of the member product registration multilevel sales Business according to the present invention.

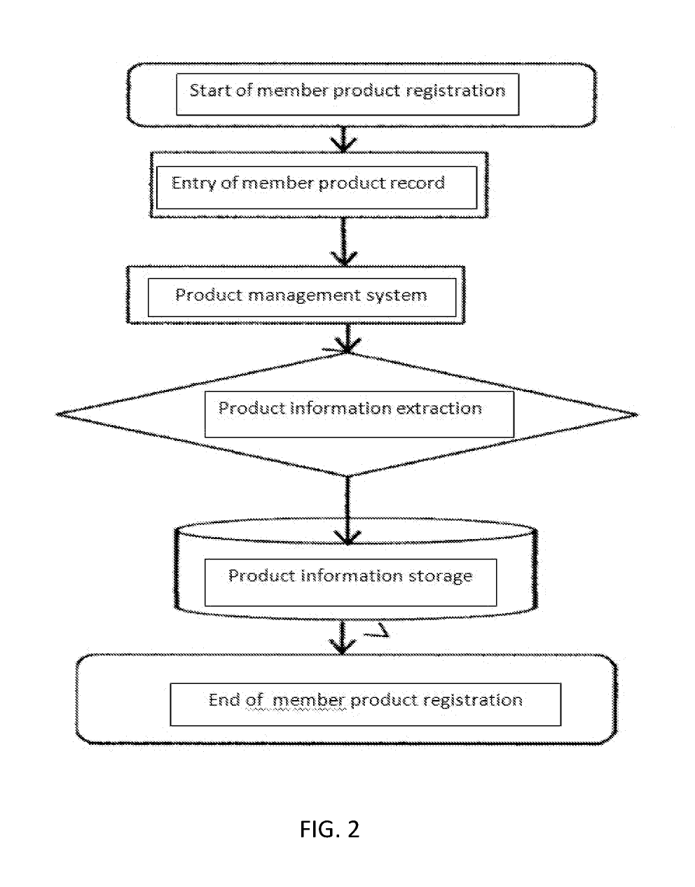

FIG. 3 is a chart of the flow of the qualification setting by the Member qualification Extraction Department of the product registration member which was installed in the qualification management system of the member product registration multilevel sales Business According to the present invention.

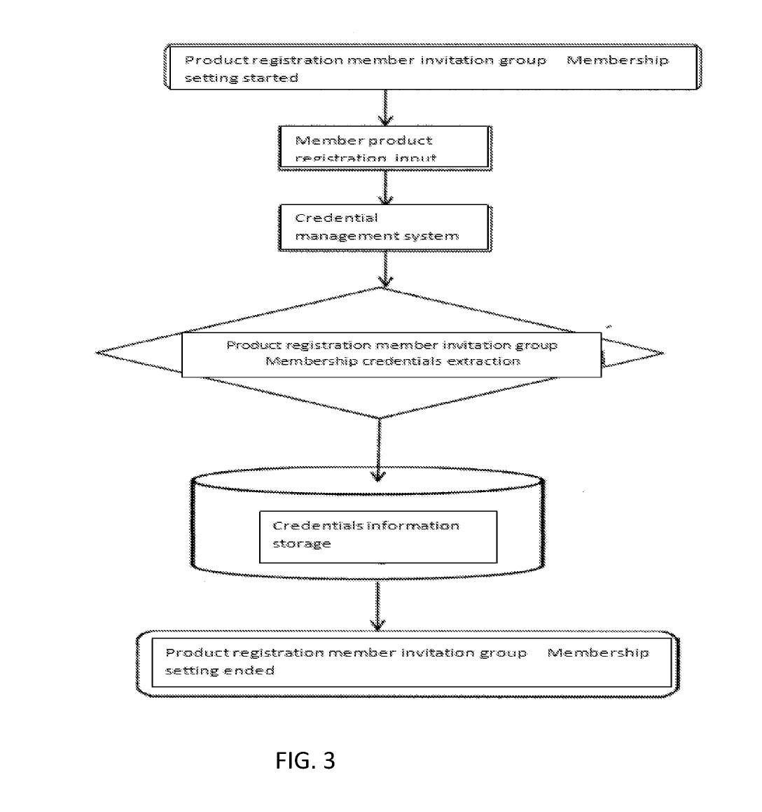

### FORMS FOR IMPLEMENTING THE INVENTION

The greatest feature of the present invention, according to claim 1, the distribution system formed by the multilevel sales business system, it is in that it is possible to sell by registering the product of the member themselves as the seller.

This required a fairly high business capacity for sales and network formation in existing multilevel sales businesses.

In this member product registration multilevel Sales Business system, since it is possible to register the product as the seller, the member who has the production power of the product can earn the profit by selling a marketable product voluntarily as a seller.

That is, unlike the existing multilevel sales business, where only those with sales force and business force are able to earn money, there is also the opportunity to earn money by planning and providing people who can find marketable and good products.

According to claim 2, not only tangible products, but also intangible services, operations, labor, etc., all acts of consideration can be registered as a commodity, so that the person who has the expert knowledge and the skill conveys it, and is an educational activity. For example, seminars can also be registered and sold as products.

According to claim 3, because it is possible to register as a commodity even if it is a single commodity, a one-time, intangible service, the business, and the labor, etc., the art such as the painting and the sculpture produced by oneself can be registered and sold as a commodity.

According to claim 4, the members of the multilevel sales business, even if they are members of the same group and affiliated groups, can register products jointly, so that all members of the group are encouraged to participate in the group.

From this member-to-member collaborative business with members beyond the group, the possibility of new products being offered is increased.

According to claim 5, in order to register the product jointly with the members of the group and the group belonging to each other according to claim 4, it is possible to register the ratio of the remuneration obtained by each member of the product registration jointly. Joint ventures are promoted through the same procedure as regular single-product registration, so that the members of the group can cooperate with each other.

1. A member product registration group that adds a new reward item to a member of multilevel sales business system comprising:
a member product information registration department which enables a member to register a product with a seller,
an order management system that manages the products registered in the member product information registration department,
the member who solicited the member who becomes the seller voluntarily is extracted, and a compensation receipt qualification is set,
a member qualification group for the recruitment of product,
a qualification management system to manage the membership of the product registration member solicitation group; and
a member product registration multilevel sales business system.

2. In addition, the members of the multilevel sales business, not only tangible products, but also intangible services, operations, labor, etc., the member product registration multilevel Sales Business system, characterized in that it is possible to register all acts arising of consideration as a product.

3. In addition, the members of the multilevel sales business shall continue to provide products that can be supplied continuously and intangible services, operations, and labor, rather than a single commodity and one-time intangible services, operations, Member product registration multilevel sales Business System according to claim 1, characterized in that it can be registered as a commodity even if labor.

4. In addition, the members of the multilevel sales business to be able to register a product jointly with a member of a network group of its own In addition, members of different network groups belonging to the membership product registration multilevel Sales Business system, which is characterized by the ability to register products jointly.

5. Further, according to claim 4 when you create a product in collaboration with a member of your own network group, In collaboration with members of different network groups When registering the product to the member Product Information Registration section of claim 1, wherein by registering the ratio of the remuneration obtained by the product of each member who jointly register the product,
the amount of each member's remuneration obtained by the sales performance of the product,
to make a system that can be calculated according to the registered compensation ratio, and the remuneration amount of the member of the Solicitation Group with the compensation qualification of each member,
the reward ratio input item is provided in the member Product information Registration unit according to claim 1,
a reward ratio extraction function is provided in the member Qualification Extraction section of the Product Registration Member solicitation Group according to claim 1,
The compensation calculation function by the reward ratio is provided for the qualification management system described in claim 1,
member product registration multilevel sales Business System according to claim 1.
